(19) United States
(12) Patent Application Publication
(10) Pub. No.: US 2009/0314045 A1
(43) Pub. Date: Dec. 24, 2009

(54) SELF-DISENGAGING LOCK FOR A CAR LOCK MECHANISM

(75) Inventors: Fabrice Giacomin, Creteil Cedex (FR); Louis Canard, Creteil Cedex (FR)

Correspondence Address: OSHA LIANG L.L.P., TWO HOUSTON CENTER, 909 FANNIN, SUITE 3500, HOUSTON, TX, 77010, US

(73) Assignee: VALEO SECURITE HABITACLE, Creteil Cedex (FR)

(21) Appl. No.: 12/159,403

(22) PCT Filed: Dec. 21, 2006
(86) PCT No.: PCT/FR06/02830

§ 371 Date: Oct. 31, 2008

(30) Foreign Application Priority Data
Dec. 30, 2005 (FR) 0554143

(51) Int. Cl. E05B 65/12; E05B 17/00

(52) U.S. Cl. 70/237

(57) ABSTRACT

A self-disengaging lock for a motor vehicle lock mechanism, including a fixed stator and a rotor which is rotatably mounted in the stator and which comprises pins which are radially mobile under the action of a key intended to be axially introduced into the rotor, where the rotor is coupled to a control device of the lock, in an angular alignment in the manner of a cardan joint, when the key is correct, and the rotor is decoupled from the control device in the disengaged position, where the rotor is coupled to the control device directly, the end of the control device having a coupling arrangement held by the stator and the end of the rotor having another complementary coupling arrangement, where the coupling of the rotor and the control device enables the angular displacement of the control device in order to ensure the angular alignment.

The invention relates to a self-disengaging lock for a car lock mechanism.

The addition of a self-disengaging mechanism to a lock intended for a car lock makes it possible to prevent said lock from being forced.

Such a self-disengaging lock is disclosed in the document of the patent WO02/097222.

Such a self-disengaging lock, in particular for a motor vehicle lock mechanism, comprises a fixed stator consisting of at least two semi-cylindrical parts, a rotor which is rotatably mounted in the stator and which comprises pins which are radially mobile under the action of a key intended to be axially introduced into the rotor, the rotor being coupled to a control lever when the key is correct, and decoupled therefrom in the disengaged position.

The disengagement is carried out by means of ribs arranged inside the stator and the rotor is coupled to an outlet element equivalent to a control lever, intended to be connected to an associated lock mechanism.

According to this known lock, the rotor and the drive element guided in rotation on the rotor are configured in a substantially end-to-end arrangement. These two parts are substantially arranged one extending from the other.

The drive element comprises a principal ring and guide tabs which extend axially from the ring and which are intended to be received in corresponding axial notches of the control lever.

This lock arrangement poses the following technical problems.

By virtue of said lock being configured in an end-to-end arrangement, such a lock has a relatively long length.

Moreover, the drive element is a relatively fragile part as a result of its structure.

The constituent parts of this lock are relatively numerous and pose a problem of angular clearance relative to one another.

Moreover, the structure of the disengaging device inside the stator may cause blocking of the pins relatively easily and wear of the stator as a result of these pins in the disengaged position.

In practice, the control lever part may consist of a cam, of the lever arm type rotating about the rotational axis of the lock, or a device in an angular alignment in the manner of a cardan joint or transmission cable, i.e. freely pivoting according to two degrees of freedom.

The invention solves these problems by proposing a particularly compact self-disengaging lock, i.e. of limited length, and of particularly robust structure, intended for a control device in an angular alignment in the manner of a cardan joint.

To achieve this, the invention proposes a self-disengaging lock, in particular for a motor vehicle lock mechanism, comprising a fixed stator, a rotor which is rotatably mounted in the stator and which comprises pins which are radially mobile under the action of a key intended to be axially introduced into the rotor, the rotor being coupled to a control device of a lock, in an angular alignment in the manner of a cardan joint, when the key is correct, and decoupled therefrom in the disengaged position, lock characterized in that coupling of the rotor and of the control device is direct, the end of the control device consisting of a first coupling arrangement held by the stator and the end of the rotor consisting of a second complementary coupling arrangement, said coupling enabling the angular displacement of said control device in order to ensure said angular alignment.

The efficiency of a lock according to the invention is furthermore improved since the kinematic chain during normal operation only comprises two parts in mutual engagement, the rotor and the control device.

According to a preferred embodiment, the lock also comprises an indexer which is axially mobile between a resting position and a disengaged position, following the driving in rotation of the rotor by means of an incorrect key, this indexer being connected directly in rotation to said control device.

Preferably, the rotor and the indexer are connected in translation.

According to a first variant, said first coupling arrangement consists of a sphere with n axial faces and in that said second arrangement consists of a corresponding housing of polygonal section with n sides.

In this case, said indexer is advantageously connected in rotation to said control device by means of a bore of polygonal section with n sides in engagement with said sphere.

According to a second variant, said first coupling arrangement consists of a housing provided with m inclined radial grooves and in that said second arrangement consists of m corresponding inclined radial ribs.

In this case, preferably, said housing forming said first coupling arrangement is arranged in a sphere with n axial faces arranged at the end of said control device and held by the stator.

Advantageously, said indexer is connected in rotation to said control device by means of a bore of polygonal section with n sides in engagement with said sphere.

The number n may be greater than or equal to six.

The number m may be greater than or equal to four.

The invention also relates to a self-disengaging lock part intended to be mounted on a control device in order to form a lock as defined above.

The invention finally relates to a control device intended to be mounted on a self-disengaging lock part in order to form a lock as indicated above. The control device may be a part belonging to a handle or a motor vehicle lock.

The invention is disclosed hereinafter in more detail with reference to the figures which only show one preferred embodiment of the invention.

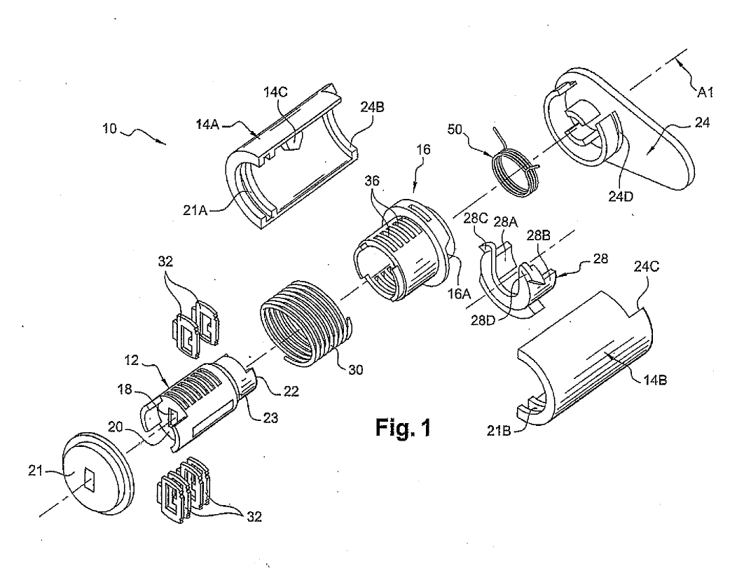

FIG. 1 is an exploded view in perspective of a self-disengaging lock.

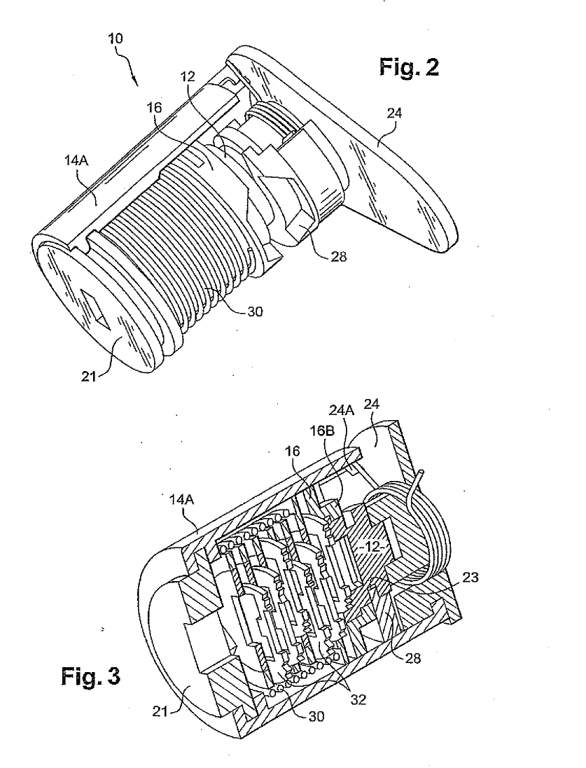

FIG. 2 is a perspective view of the self-disengaging lock, in the initial position.

FIG. 3 is a view in transverse section in the position before disengagement.

FIG. 4 is a perspective view of a lock, in the engaged position, the stator only being partially shown and the compression spring not being shown.

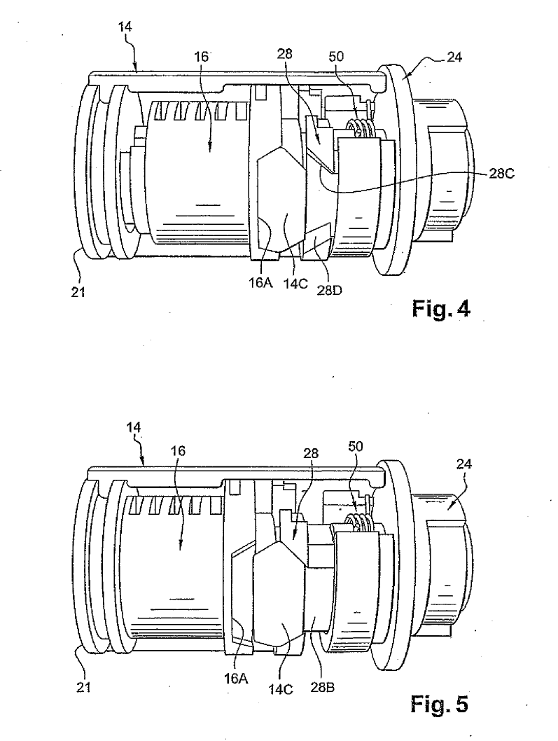

FIG. 5 is a perspective view of a lock, in the disengaged position, the stator only being partially shown and the compression spring not being shown.

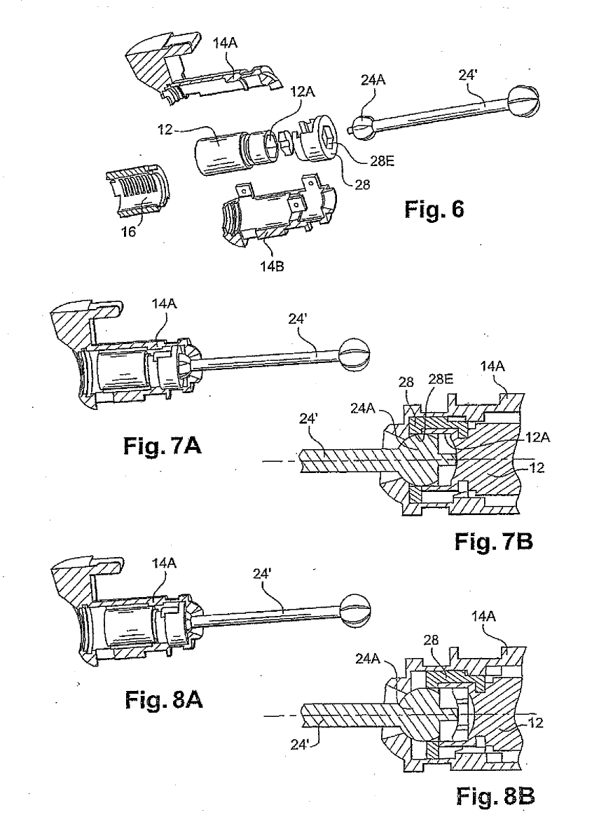

FIG. 6 is an exploded perspective view of a lock, in the initial position, according to a first variant of the invention.

FIGS. 7A and 7B are views in perspective and longitudinal section of a lock, in the initial position, according to said same first variant of the invention.

FIGS. 8A and 8B are views in perspective and in longitudinal section of a lock, in the disengaged position, according to said same first variant of the invention.

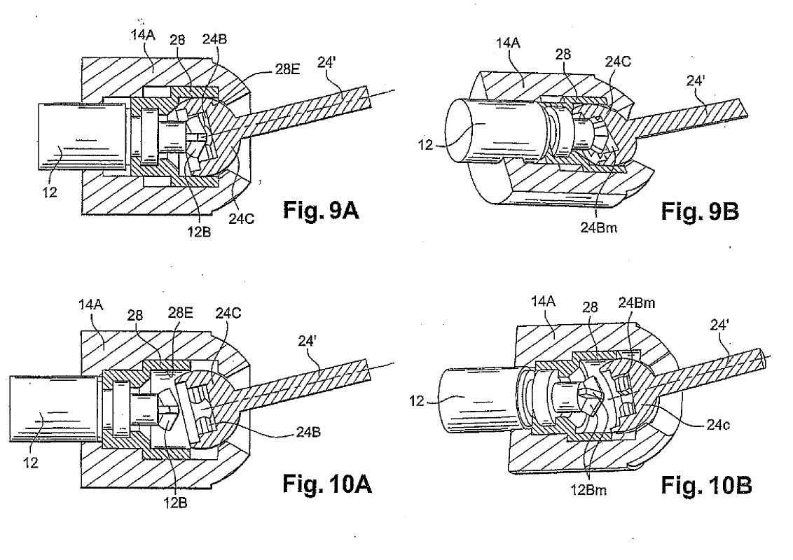

FIGS. 9A and 9B are views in longitudinal section and in perspective of a lock, in the initial position, according to a second variant of the invention.

FIGS. 10A and 10B are views in longitudinal section and in perspective of a lock, in the disengaged position, according to a second variant of the invention.

In FIG. 1 a rotating lock of longitudinal axis A1 is shown comprising means for disengagement according to the teaching of the invention. This lock is shown in FIG. 2 in the initial position before the introduction of a key.

The lock 10 essentially comprises a rotor 12 which is rotatably mounted, about the axis A1, inside a fixed stator 14 consisting of two semi-cylindrical parts 14A and 14B, with the interposition therebetween of an intermediate tubular sleeve 16 which is rotatably mounted about its axis in the stator and which is axially mobile relative to the stator.

This intermediate sleeve 16 comprises, in the vicinity of its front face turned towards the cam 24 on a portion of its periphery, a notch 16A of which the sides are inclined. Moreover, this sleeve is in abutment against the rotor due to an annular flange 16B (visible in FIG. 3), in a direction oriented from the cam to the key inlet.

The rotor 12 is intended to be driven in rotation using a key (not shown) introduced axially inside the rotor 12 through a key inlet 18 arranged in a front transverse face 20 of the rotor 12, which face 20 is covered by a top cover 21 which is intended, for example, to be flush with the outside of a bodywork panel (not shown) of the vehicle.

The rear axial end 22 of the rotor 12 is intended to drive in rotation a control lever or cam 24 intended to be connected to a lock mechanism (not shown) to allow the locking and unlocking of an opening of the vehicle.

The rotor 12 is capable of driving in rotation the control lever 24, only in the presence of a correct key, into an engaged position in which the rotor 12 and the control lever 24 are connected in rotation by means of an interlocking arrangement. In a disengaged position, the rotor 12 is no longer capable of driving the lever 24 in rotation.

A helical compression spring 30 is interposed between the stator 14 and the intermediate sleeve 16 to urge said intermediate sleeve axially toward the rear into its engaged position.

The stator 14 is of generally cylindrical tubular shape once the two parts 14A, 14B are assembled and it may comprise means (not shown) which permit the mounting and fixing of the lock 10 to the vehicle. The stator comprises on its internal face an abutment and guide stud 14C, of which the sides have a V-shape which is tangential relative to this internal face on each of its ends. In the engaged position, the notch 16A of the intermediate sleeve interlocks with this abutment and guide stud 14C under the action of the compression spring 30.

In the known manner, the rotor 12 is intended to receive pins 32 arranged in transverse planes and in succession at regular intervals in the direction of the axis A1 of the lock 10 and which are received in corresponding housings of the rotor 12.

The pins 32 are radially mobile in the rotor 12 and they are urged elastically toward a projecting position in which they partially protrude beyond the outside of the housings of the rotor 12.

In contrast, when a correct key is introduced inside the rotor 12, the pins 32 are fully retracted radially toward the inside of the rotor 12.

Thus, when the correct key is introduced into the rotor 12, said rotor may pivot freely relative to the cylindrical intermediate sleeve 16 and relative to the stator 14.

In contrast, if an incorrect key is introduced into the rotor 12, or any other tool, as illustrated in FIG. 3, the pins 34 are not fully retracted and are received inside corresponding apertures 36 arranged in the intermediate sleeve 16. Thus, the pins 34 immobilize the rotor 12 in rotation relative to the intermediate sleeve 16 which, itself, remains free in rotation relative to the stator 14.

An indexer 28 consists of an open ring which is clipped into a groove 23 arranged in the vicinity of the end 22 of the rotor turned toward the cam 24. The indexer 28 is thus connected in translation to the rotor. On this ring are arranged in the direction of the cam two tongues 28A, 28B which may be inserted into the cam 24. On its face turned toward the rotor, the indexer 28 comprises two inclined faces 28C and 28D. As will be seen below, these two inclined faces are in abutment against the abutment and guide stud 14C of the stator in the disengaged position.

The lock 10 also comprises a restoring spring 50 operating in torsion and serving to return the cam 24 into the initial position.

The operation of the lock according to the invention will now be described with reference to the other figures.

In FIG. 4, a correct key has been introduced into the rotor 12 through the key inlet 18, and the lock is thus in the engaged position. The pins 32 are thus retracted inside the rotor 12 which may rotate in the intermediate sleeve 16.

In this position, the rotor 12 may be rotated with the key and drives therewith the cam 24 in rotation, releasing the lock.

The intermediate sleeve 16 remains fixed in rotation, connected to the stator 14 by the abutment and guide stud 14C and the indexer 28 rotates freely with the cam 24 by means of its tabs 28A and 28B.

The rotation of the cam 24 is obtained by the rotation of the following parts: key/rotor/cam.

At the end of the path, when the key is released, the restoring spring 50 of which one end is fixed and a further end is in abutment against a flange 24A of the cam 24, brings the cam back into the initial position in addition to the drive element and the rotor.

In FIGS. 3 and 5, an incorrect key has been introduced into the rotor 12 through the key inlet 18 and the lock is thus in the disengaged position. The pins 32 are thus not retracted inside the rotor 12 which is, as a result, connected in rotation to the intermediate sleeve 16 by inserting the pins therein.

The rotation of the incorrect key thus drives in rotation the rotor 12 and the intermediate sleeve 16, which are connected to one another. This intermediate sleeve 16, by virtue of the cooperation of one side of the V-shape of the abutment and guide stud 14C, turned toward the rotor, and an inclined face of the notch 16A of the sleeve, is translated in the direction of the key inlet counter to the force of the compression spring 30. As a result of its annular flange 16B, the intermediate sleeve 16 drives therewith the rotor 12 in this translational motion in the direction of the key inlet. The rotor is thus disconnected from its interlocking with the cam 24. Moreover, as the rotor 12 and the indexer 28 are connected in translation, the indexer is also displaced in the same direction and its inclined faces 28C and 28D are brought into abutment against the sides of the V-shape of the abutment and guide stud 14C, turned toward the cam. In this position, it is immobilized and blocks the cam by means of its interlocking members 28A, 28B.

The deliberate rotation of the key thus causes the displacement of the following parts: translation of the intermediate sleeve/translation of the rotor/translation of the indexer/locking in rotation of the cam.

During the subsequent introduction of a correct key, the rotor 12 is rotated due to the rotation of the key as far as its initial position shown in FIG. 2, then the key is engaged if the key is correct or is disengaged if the key is incorrect.

The lock according to the invention is provided with a shielded rotor head 21, for example made of sintered steel. The stator 14 which is made up of two parts also improves the resistance to impacts.

This lock has the feature of increased inviolability relative to the prior art.

The two parts of the stator 14A, 14B enclose the constituent parts of the lock and block by means of one of their ends the key head 21 by means of a groove 21A, 21B arranged at this end and into which the key head is fitted. At the other end of said constituent parts, they are blocked by means of a flange 24B, 24C in an annular groove 24D arranged on the cam 24.

The lock disclosed above comprises a control device consisting of a cam 24.

According to the invention, instead of a cam, a control device is used in an angular alignment in the manner of a cardan joint 241 as shown in FIGS. 6 to 10.

Apart from this adaptation, the lock is identical to that already disclosed and thus essentially comprises a fixed stator 14A, 14B, a rotor 12 which is mounted in rotation in the stator and which comprises pins which are radially mobile under the action of a key intended to be introduced axially into the rotor, the rotor being coupled to the control device 24′ of a lock, in an angular alignment in the manner of a cardan joint, when the key is correct, and decoupled therefrom in the disengaged position, when the key is incorrect, the rotor 12 and the control device 24′ being directly coupled together.

The end of the control device 24′ on the lock side consists of a first coupling arrangement 24A, 24B held by the stator 14A, 14B and the end of the rotor 12 consists of a second complementary coupling arrangement 12A, 12B, this coupling permitting the angular displacement of the control device 24′ in order to ensure the angular alignment.

The lock also comprises an indexer 28 which is mobile axially between a resting position and a disengaged position, following the driving in rotation of the rotor 12 using an incorrect key, this indexer being connected directly in rotation to the control device 24′. The rotor 12 and the indexer 28 are connected in translation.

According to a first variant shown in FIGS. 6 to 8, the first coupling arrangement consists of a sphere 12A with n axial faces, advantageously six axial faces or more, and the second arrangement of a housing 12A of polygonal section with n corresponding sides, advantageously of hexagonal section.

The indexer 28 is connected in rotation to the control device 24′ by means of a bore 28E of polygonal section with n sides, advantageously of hexagonal section, in engagement with the sphere 12A.

In FIGS. 7A and 78, a correct key has been introduced into the rotor 12 through the key inlet and the lock is thus in the engaged position.

In this position, the rotor 12 may be rotated with the key and drives therewith the control device 24′ in rotation, by the interlocking of its coupling housing 12A with the sphere 24A of this control device.

The intermediate sleeve remains immobile in rotation, connected to the stator 14 by the abutment and guide stud and the indexer 28 rotates freely with the control device 24′ by the interlocking of the sphere 24A of the control device in the coupling bore 288 of the indexer.

In FIGS. 8A and 8B, an incorrect key has been introduced into the rotor 12 through the key inlet and the lock is thus in the disengaged position.

The rotation of the incorrect key thus drives in rotation the rotor 12 and the intermediate sleeve which are connected to one another. This intermediate sleeve 16 is translated in the direction of the key inlet counter to the force of the compression spring. By means of its annular flange, the intermediate sleeve 16 drives therewith the rotor 12 in this translational motion in the direction of the key inlet. The rotor is thus disconnected from its interlocking with the sphere 24A of the control device 24′. Moreover, as the rotor 12 and the indexer 28 are connected in translation, the indexer is also displaced in the same direction and its inclined faces are brought into abutment against the sides of the V-shape of the abutment and guide stud, rotated towards the control device. In this position, it is immobilized and locks the control device 24′, still being in engagement with the sphere 24A, by virtue of its length and the positioning of its coupling bore 28E.

During the subsequent introduction of a correct key, the rotor 12 is rotated due to the rotation of the key as far as the initial position shown in FIGS. 8A and 8B, then the lock is engaged it the key is correct or is disengaged if the key is incorrect.

According to a second variant shown in FIGS. 9 and 10, the first coupling arrangement consists of a housing 24B provided with m inclined radial grooves 24Bm, advantageously four or more in number, and the second arrangement 12B of m corresponding inclined radial ribs 12Bm, advantageously four in number.

In this case, the housing 24B forming the first coupling arrangement is arranged in a sphere 24C with n axial faces, advantageously six in number, arranged at the end of the control device 24T and held by the stator 14A, 14B. The indexer 28 is connected in rotation to the control device by means of a bore of polygonal section with n sides, advantageously six in number, in engagement with the sphere 24C.

In FIGS. 9A and 9B, a correct key has been introduced into the rotor 12 through the key inlet and the lock is thus in the engaged position.

In this position, the rotor 12 may be rotated with the key and drives the control device 24′ therewith in rotation, by the interlocking of its inclined radial ribs 12Bm in the corresponding inclined grooves 24Bm of said control device.

The intermediate sleeve remains immobile in rotation, connected to the stator 14 by the abutment and guide stud and the indexer 28 rotates freely with the control device 24′ by the interlocking of the sphere 24C of the control device in the coupling bore 28E of the indexer.

In FIGS. 10A and 10B, an incorrect key has been introduced into the rotor 12 through the key inlet and the lock is thus in the disengaged position.

The rotation of the incorrect key thus drives in rotation the rotor 12 and the intermediate sleeve which are connected to one another. This intermediate sleeve 16 is translated in the direction of the key inlet counter to the force of the compression spring. By means of its annular flange, the intermediate sleeve 16 drives therewith the rotor 12 in this translational motion in the direction of the key inlet. The rotor is thus disconnected from its interlocking with the housing with radial grooves 24B of the control device 24′. Moreover, as the rotor 12 and the indexer 28 are connected in translation, the indexer is also displaced in the same direction and its inclined faces are brought into abutment against the sides of the V-shape of the abutment and guide stud, rotated towards the control device. In this position, it is immobilized and locks the control device 24′, as it is still in engagement with the sphere 24A by virtue of its length and the positioning of its coupling bore 28E.

During the subsequent introduction of a correct key, the rotor 12 is rotated due to the rotation of the key as far as the initial position shown in FIGS. 10A and 10B, then the lock is engaged if the key is correct or is disengaged if the key is incorrect.

1. A self-disengaging lock for a motor vehicle lock mechanism, comprising:
a fixed stator,
a rotor which is rotatably mounted in the stator and which comprises pins which are radially mobile under the action of a key intended to be axially introduced into the rotor,
wherein the rotor is coupled to a control device of the lock, in an angular alignment in the manner of a cardan joint, when the key is correct, and decoupled therefrom in the disengaged position,
wherein said coupling of the rotor and of the control device is direct, the end of the control device consisting of a first coupling arrangement held by the stator and the end of the rotor consisting of a second complementary coupling arrangement said coupling enabling the angular displacement of said control device in order to ensure said angular alignment.

2. The lock as claimed in claim 1, wherein the lock further comprises an indexer which is axially mobile between a resting position and a disengaged position, following the driving in rotation of the rotor by means of an incorrect key, this indexer being connected directly in rotation to said control device.

3. The lock as claimed in claim 2, wherein the rotor and the indexer are connected in translation.

4. The lock as claimed in claim 1, wherein said first coupling arrangement consists of a sphere with n axial faces and in that said second arrangement consists of a corresponding housing of polygonal section with n sides.

5. The lock as claimed in claim 3, wherein said indexer is connected in rotation to said control device by means of a bore of polygonal section with n sides in engagement with said sphere.

6. The lock as claimed in claim 1, wherein said first coupling arrangement consists of a housing provided with m inclined radial grooves and in that said second arrangement consists of m corresponding inclined radial ribs.

7. The lock as claimed in claim 6, wherein said housing forming said first coupling arrangement is arranged in a sphere with n axial faces arranged at the end of said control device and held by the stator.

8. The lock as claimed in claim 3, wherein said indexer is connected in rotation to said control device by means of a bore of polygonal section with n sides in engagement with said sphere.

9. The lock as claimed in claim 4, wherein said number n is greater than or equal to six.

10. The lock as claimed in claim 6, wherein said number m is greater than or equal to four.

11. A self-disengaging lock part intended to be mounted on a control device in order to form a lock as claimed in claim 1.

12. A control device intended to be mounted on a self-disengaging lock part in order to form a lock as claimed in claim 1.
